(19) United States
(12) Patent Application Publication
(10) Pub. No.: US 2011/0074818 A1
(43) Pub. Date: Mar. 31, 2011

(54) IMAGE PROCESSING APPARATUS AND IMAGE PROCESSING METHOD

(76) Inventor: Tomonori MASUDA, Saitama-shi (JP)

(21) Appl. No.: 12/890,322

(22) Filed: Sep. 24, 2010

(30) Foreign Application Priority Data
Sep. 25, 2009 (JP) 2009-221168

(51) Int. Cl. G09G 5/377; G09G 5/00

(52) U.S. Cl. 345/634; 345/619

(57) ABSTRACT

An image processing method including: inputting a plurality of images with a parallax between the images; by using one of the plurality of inputted images as a reference image, computing a parallax for each of pixels of the reference image on the basis of the plurality of images; extracting an unknown-parallax region for which a parallax cannot be computed; displaying the unknown-parallax region on a display device; receiving a user input of information on a parallax for the unknown-parallax region from a user; and setting the parallax for the unknown-parallax region on the basis of the input information on the parallax.

### BACKGROUND OF THE INVENTION

1. Field of the Invention

The presently disclosed subject matter relates to an image processing apparatus and an image processing method and, more particularly, to an image processing apparatus and an image processing method for appropriately setting a parallax for a region of stereo images for which parallax estimation is difficult or impossible.

2. Description of the Related Art

A technique for generating an image with an arbitrary intermediate viewpoint from two images with different viewpoints taken as stereo images is important in displaying an appropriate stereoscopic image on various stereoscopic image display devices including a stereophotographic print with a lenticular lens sheet attached to its surface.

In order to generate an image with an intermediate viewpoint, it is necessary to compute a pixel difference (parallax) between each pixel of one of two images with different viewpoints which is used as a reference and a pixel corresponding to the pixel of the other image and create a map of parallaxes (a parallax map) for one screen.

The creation of the parallax map suffers from the problem in that one of the two images with the different viewpoints has a blind region (an occlusion region), to which no region of the other image corresponds, and a parallax cannot be computed for the occlusion region.

In order to solve the problem, according to Japanese Patent Application Laid-Open No. 9-27969, search windows are set on left and right sides of a contour of an object in an occlusion region, the variance of parallax within each of the left and right search windows is obtained, a part of the occlusion region is considered to be present on the side of the search window with larger variance, and a parallax for the part of the occlusion region is corrected to one of parallaxes for the search window with the larger variance indicating a long distance.

### SUMMARY OF THE INVENTION

In Japanese Patent Application Laid-Open No. 9-27969, an occlusion region is determined by using the fact that the same pixels of left and right images do not correspond to each other in an occlusion region, a parallax is tentatively assigned to the occlusion region, and the occlusion region is considered to be present on the side of the search window with larger variance from the variance of parallax within each of search windows set on left and right sides of a contour of an object. However, it is not always true that the same pixels of left and right images (a left eye image and a right eye image) do not correspond to each other in an occlusion region, and a parallax for the occlusion region (a parallax tentatively assigned because of the inability to detect a parallax for the occlusion region) is also used to compute the variance of parallax. Accordingly, a variance to be computed is unreliable.

The presently disclosed subject matter has been made in consideration of the circumstances, and has its object to provide an image processing apparatus and an image processing method for appropriately setting a parallax for a region for which parallax estimation is difficult or impossible, such as an occlusion region.

In order to achieve the above-described object, a first aspect of the presently disclosed subject matter provides an image processing apparatus including: an image input device configured to input a plurality of images with a parallax between the images; a parallax computation device configured to set one of the plurality of inputted images as a reference image and compute a parallax for each of pixels of the reference image on the basis of the plurality of images; a first extraction device configured to extract an unknown-parallax region for which a parallax cannot be computed by the parallax computation device; a display control device configured to display the unknown-parallax region on a display device; an input device configured to receive a user input of information on a parallax for the unknown-parallax region from a user; and a parallax setting device configured to set the parallax for the unknown-parallax region on the basis of the input information on the parallax.

According to the first aspect, a parallax is computed for each of pixels of a plurality of inputted images with a parallax between the images, an unknown-parallax region for which a parallax cannot be computed is displayed on a display device, a user is prompted to enter information on a parallax for the unknown-parallax region, and the parallax for the unknown-parallax region is set on the basis of the entered information on the parallax. Accordingly, a parallax for a region for which parallax estimation is impossible, such as an occlusion region, can be appropriately set.

A second aspect of the presently disclosed subject matter provides an image processing apparatus according to the first aspect, wherein the input device includes: a specification device configured to receive a user instruction to specify any one region within the plurality of images; and an acquisition device configured to acquire a parallax computed by the parallax computation device for the specified region, and the parallax setting device sets the parallax acquired by the acquisition device as the parallax for the unknown-parallax region.

This configuration allows appropriate setting of a parallax for an unknown-parallax region.

A third aspect of the presently disclosed subject matter provides an image processing apparatus according to the first aspect, wherein the input device includes: a specification device configured to receive an user instruction to specify any two regions within the plurality of images; an acquisition device configured to acquire parallaxes computed by the parallax computation device for the two specified region; and an intermediate parallax computation device configured to compute a parallax intermediate between the two parallaxes acquired by the acquisition device, and the parallax setting device sets the parallax computed by the intermediate parallax computation device as the parallax for the extracted unknown-parallax region.

This configuration allows appropriate setting of a parallax for an unknown-parallax region.

A fourth aspect of the presently disclosed subject matter provides an image processing apparatus according to the first aspect, further including: an acquisition device configured to receive a user instruction to specify any one region within the plurality of images and acquire a parallax computed by the parallax computation device for the specified region; an intermediate parallax computation device configured to receive a user instruction to specify any two regions within the plurality of images, acquire parallaxes computed by the parallax computation device for the two specified regions, and compute a parallax intermediate between the two acquired parallaxes; and a selection device configured to select from a first option of setting the parallax acquired by the acquisition device as the parallax for the unknown-parallax region by the parallax setting device and a second option of setting the parallax computed by the intermediate parallax computation device as the parallax for the unknown-parallax region by the parallax setting device.

This configuration allows a user to set a parallax for an unknown-parallax region with use of the user's favorite method.

A fifth aspect of the presently disclosed subject matter provides an image processing apparatus according to any one of the first to fourth aspects, further including a first dividing device configured to divide the unknown-parallax region into a plurality of regions, wherein the input device receives a user input of information on the parallax for the unknown-parallax region for each of the divided regions.

This configuration allows appropriate setting of a parallax even in a case where a plurality of parallaxes need to be set for an unknown-parallax region.

A sixth aspect of the presently disclosed subject matter provides an image processing apparatus according to any one of the first to fifth aspects, wherein the display control device superimposes the unknown-parallax region on at least one of the plurality of images and displays the at least one image on the display device.

This configuration allows a user to appropriately recognize an unknown-parallax region.

A seventh aspect of the presently disclosed subject matter provides an image processing apparatus according to any one of the first to fifth aspects, further including a second dividing device configured to divide the reference image into components within different predetermined distance ranges on the basis of the parallaxes for the pixels computed by the parallax computation device, wherein the display control device superimposes a dividing line by which the reference image is divided on the reference image and displays the reference image.

This configuration facilitates entry of information on a parallax.

An eighth aspect of the presently disclosed subject matter provides an image processing apparatus according to any one of the first to fifth aspects, further including a generating device configured to generate a parallax image of the reference image on the basis of the parallaxes for the pixels computed by the parallax computation device, wherein the display control device superimposes the unknown-parallax region on the parallax image and displays the parallax image on the display device.

This configuration facilitates entry of information on a parallax.

A ninth aspect of the presently disclosed subject matter provides an image processing apparatus according to the eighth aspect, further including a second extraction device configured to extract a color contour from the reference image, wherein the display control device superimposes the color contour on the parallax image and displays the parallax image on the display device.

This configuration facilitates entry of information on a parallax.

A tenth aspect of the presently disclosed subject matter provides an image processing apparatus according to any one of the first to fifth aspects, further including a parallax-by-parallax image generating device configured to divide the reference image according to parallax on the basis of the parallaxes for the pixels computed by the parallax computation device and generate a plurality of parallax-by-parallax images, wherein the display control device displays the parallax-by-parallax images in order of parallax on the display device, and the input device receives a user input of information on the parallax for the unknown-parallax region in association with positions of the parallax-by-parallax images displayed in order of parallax.

This configuration facilitates entry of information on a parallax.

An eleventh aspect of the presently disclosed subject matter provides an image processing apparatus according to any one of the first to fifth aspects, wherein the input device receives an user input of a reference line with respect to the unknown-parallax region displayed on the display device which is information on the parallax for the unknown-parallax region, and the parallax setting device includes: a parallax approximate line generating device configured to generate a parallax approximate line on the basis of the reference line and a parallax setting device configured to set the parallax for the unknown-parallax region on the basis of the parallax approximate line.

This configuration facilitates entry of information on a parallax.

In order to achieve the above-described object, a twelfth aspect of the presently disclosed subject matter provides an image processing method including: an image input step of inputting a plurality of images with a parallax between the images; a parallax computation step of using one of the plurality of inputted images as a reference image and computing a parallax for each of pixels of the reference image on the basis of the plurality of images; an extraction step of extracting an unknown-parallax region for which a parallax cannot be computed by the parallax computation step; a display control step of displaying the unknown-parallax region on a display device; an input step of receiving a user input of information on a parallax for the unknown-parallax region from a user; and a parallax setting step of setting the parallax for the unknown-parallax region on the basis of the input information on the parallax.

According to the presently disclosed subject matter, it is possible to appropriately set a parallax for a region for which parallax estimation is impossible, such as an occlusion region.

### BRIEF DESCRIPTION OF THE DRAWINGS

FIG. 1 is a block diagram illustrating an image processing apparatus according to a first embodiment of the presently disclosed subject matter;

FIGS. 2A and 2B are views illustrating an example of left and right images taken as stereo images, respectively;

FIG. 3 is a view of an unknown-parallax region superimposed on an image;

FIGS. 4A and 4B are views illustrating the unknown-parallax region divided by a dividing line;

FIGS. 5A to 5C are views of displays with a message prompting for division of the unknown-parallax region;

FIGS. 6A to 6C are views of displays with messages prompting for specification of distances for divided unknown-parallax regions;

FIGS. 7A to 7C are views of displays with a message prompting for specification of a spot at the same distance as each of the divided unknown-parallax regions;

FIG. 8 is a block diagram illustrating an image processing apparatus according to a second embodiment;

FIG. 9 is a view of a display with a message prompting for specification of a spot at the same distance as each of divided unknown-parallax regions;

FIG. 10 is a block diagram illustrating an image processing apparatus according to a third embodiment; and

FIGS. 11A and 11B are views of a display with a message prompting entry of a reference line.

### DETAILED DESCRIPTION OF THE PREFERRED EMBODIMENTS

Preferred embodiments of an image processing apparatus and an image processing method according to the presently disclosed subject matter will be described below with reference to the accompanying drawings.

### First Embodiment

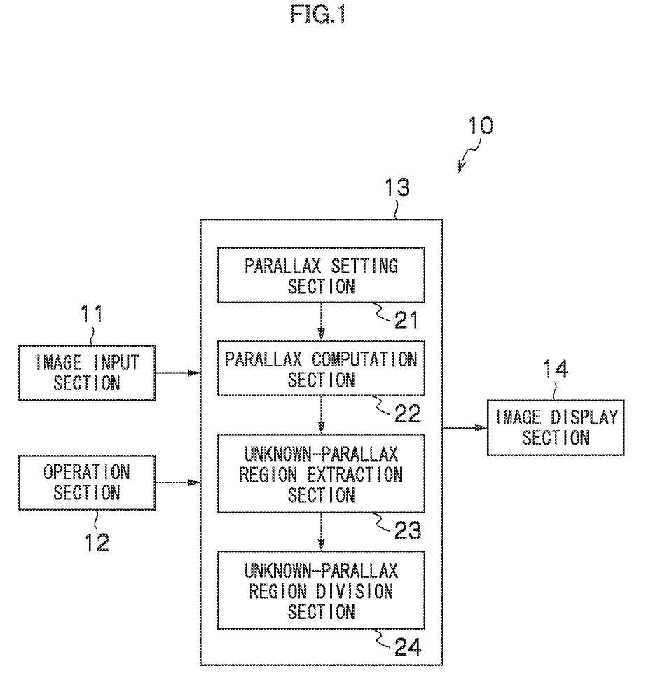

FIG. 1 is a block diagram illustrating an image processing apparatus 10 according to a first embodiment of the presently disclosed subject matter. As illustrated in FIG. 1, the image processing apparatus 10 is, for example, a personal computer or a workstation and includes an image input section 11, an operation section 12, an image processing section 13, and an image display section 14.

The image input section 11 receives inputted left and right images (a left eye image and a right eye image) taken as stereo images. The image input section 11 is composed by, for example, an image reading device which reads a multi-picture file (MP file) obtained by connecting images with multiple viewpoints for a stereoscopic image from a recording medium having the MP file recorded thereon or a device which acquires an MP file over a network.

The operation section 12 is composed of input devices of a general computer, such as a keyboard and a pointing device.

The image processing section 13 performs image processing on image data based on an image file acquired by the image input section 11 and includes a parallax setting section 21, a parallax computation section 22, an unknown-parallax region extraction section 23 and an unknown-parallax region division section 24.

The parallax setting section 21 sets a parallax which is set through the operation section 12 for an unknown-parallax region (to be described later). The parallax computation section 22 computes a parallax for each pixel on the basis of stereo image data inputted from the image input section 11 and creates a parallax map. The unknown-parallax region extraction section 23 extracts a region for which the parallax computation section 22 cannot compute a parallax. The unknown-parallax region division section 24 divides the region extracted by the unknown-parallax region extraction section 23 on the basis of an input from the operation section 12 (to be described later).

The image display section 14 is a display section which displays an image inputted from the image input section 11 and a user interface screen and is, for example, an LCD (liquid crystal display) panel or a plasma display panel. The image display section 14 is preferably a 3D (three dimensional) monitor capable of displaying left and right images inputted from the image processing section 13 in 3D. Examples of the 3D monitor include a parallax barrier type monitor and a lenticular lens type monitor. Note that the image display section 14 may be configured to have a touch panel, and the touch panel may be used as the operation section 12.

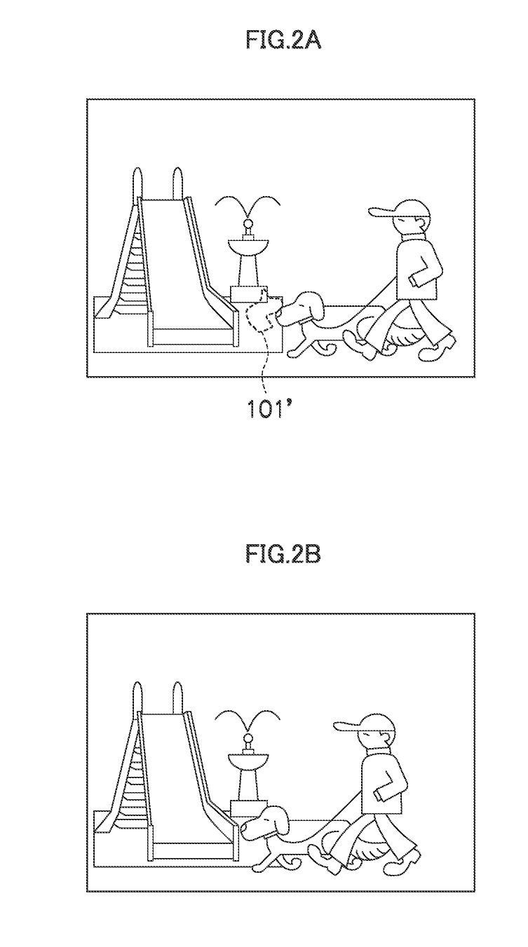

FIGS. 2A and 2B are views illustrating an example of left and right images taken as stereo images. FIG. 2A illustrates a left image (left eye image), and FIG. 2B illustrates a right image (right eye image). In this example, an occlusion region 101′ which is absent in the right image is present within the left image illustrated in FIG. 2A.

When the left image and right image illustrated in FIGS. 2A and 2B are inputted from the image input section 11, the parallax computation section 22 finds a pixel of the right image corresponding to each pixel of the left image used as the reference in this embodiment. A search for a corresponding pixel is made by using, for example, block matching. The parallax computation section 22 computes a parallax between each pixel in the left image and the searched-for corresponding pixel in the right image and creates a parallax map indicating parallaxes for one screen.

The unknown-parallax region extraction section 23 extracts a region with an unknown parallax on the basis of the parallax map created by the parallax computation section 22. As described above, a parallax cannot be computed for an occlusion region. In the example of the stereo images in FIGS. 2A and 2B, the unknown-parallax region includes the occlusion region 101′.

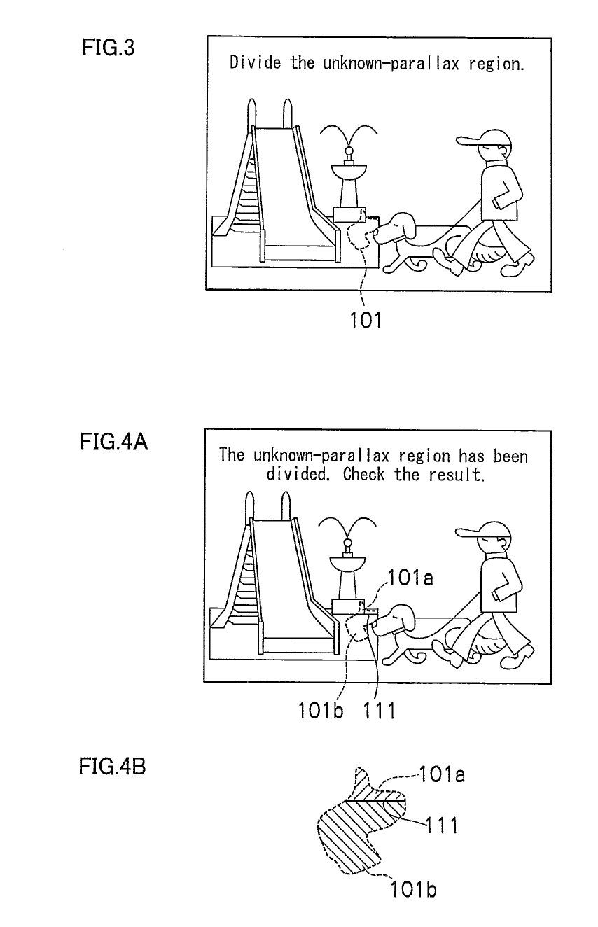

FIG. 3 is a view illustrating an example in which an unknown-parallax region 101 extracted by the unknown-parallax region extraction section 23 is clearly illustrated on the left image used as the reference, and the left image is displayed on the image display section 14. In the example, the unknown-parallax region 101 is displayed surrounded with a dashed frame. The message “Divide the unknown-parallax region.” is simultaneously displayed in order to prompt a user to divide the unknown-parallax region 101 according to parallax.

The user divides the unknown-parallax region 101 according to parallax (distance) with use of the pointing device or the like. FIG. 4A is a view illustrating the unknown-parallax region 101 divided by a dividing line 111, and FIG. 4B is an enlarged view of the unknown-parallax region 101. As illustrated in FIG. 4B, the unknown-parallax region 101 is divided into unknown-parallax regions 101a and 101b by the dividing line 111. Of subjects within the image, the dividing line 111 is drawn at a portion corresponding to the border between a region of the ground and a region of a fountain. Note that although the dividing line 111 is a straight line in this example, the configuration is preferably such that an unknown-parallax region can be divided by an arbitrary curved dividing line.

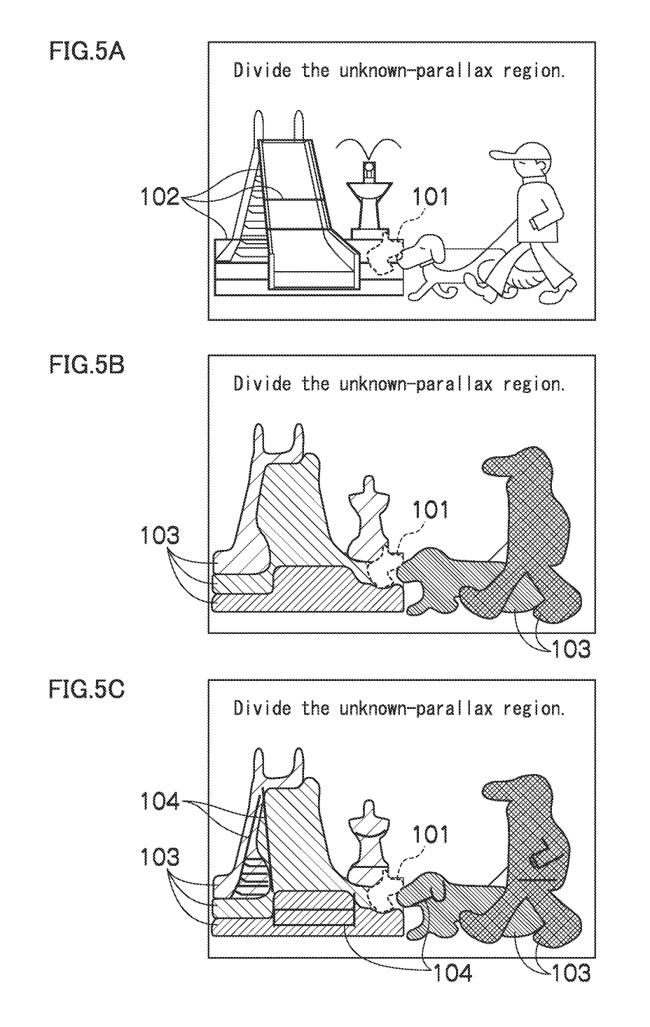

For division of the unknown-parallax region 101, pieces of distance information are desirably present in a displayed image. FIG. 5A illustrates an example in which distances are divided into ranges, and a distance border line 102 between adjacent groups of divided distances is superimposed on the image, and the image is displayed on the image display section 14. The user can appropriately divide the unknown-parallax region 101 according to the distances by checking each distance border line 102.

When the user is to divide the unknown-parallax region 101, a parallax image (parallax map) or a distance image may be displayed on the image display section 14. FIG. 5B illustrates an example in which the unknown-parallax region 101 is superimposed on a distance image, and the distance image is displayed on the image display section 14. In this example, a distance image in which a portion at a shorter distance is displayed in a darker color is used. The user can appropriately divide the unknown-parallax region 101 according to the distances by checking the distance image.

The distance image illustrated in FIG. 5B is devoid of pictorial information (color information) of the reference image and may be obscure to the user. Color contour lines 104 of the reference image may be superimposed on the distance image, as illustrated in FIG. 5C, to improve visibility for the user.

The unknown-parallax region 101 may be displayed on an enlarged scale to facilitate division of the unknown-parallax region 101 by the user. Alternatively, the configuration may be such that the user can select a desired one from among these display styles.

Note that the unknown-parallax region division section 24 may automatically divide the unknown-parallax region along a color contour on the basis of the color information of the reference image and display the dividing line 111 based on the division, instead of prompting the user to divide the unknown-parallax region. In this case, the configuration is preferably such that the user can modify the dividing line 111.

A parallax is set for each of the divided unknown-parallax regions 101a and 101b. In the setting, the user is prompted to specify a region at the same distance as each of the unknown-parallax regions 101a and 101b. The parallaxes for the specified regions are respectively assigned as parallaxes for the unknown-parallax regions.

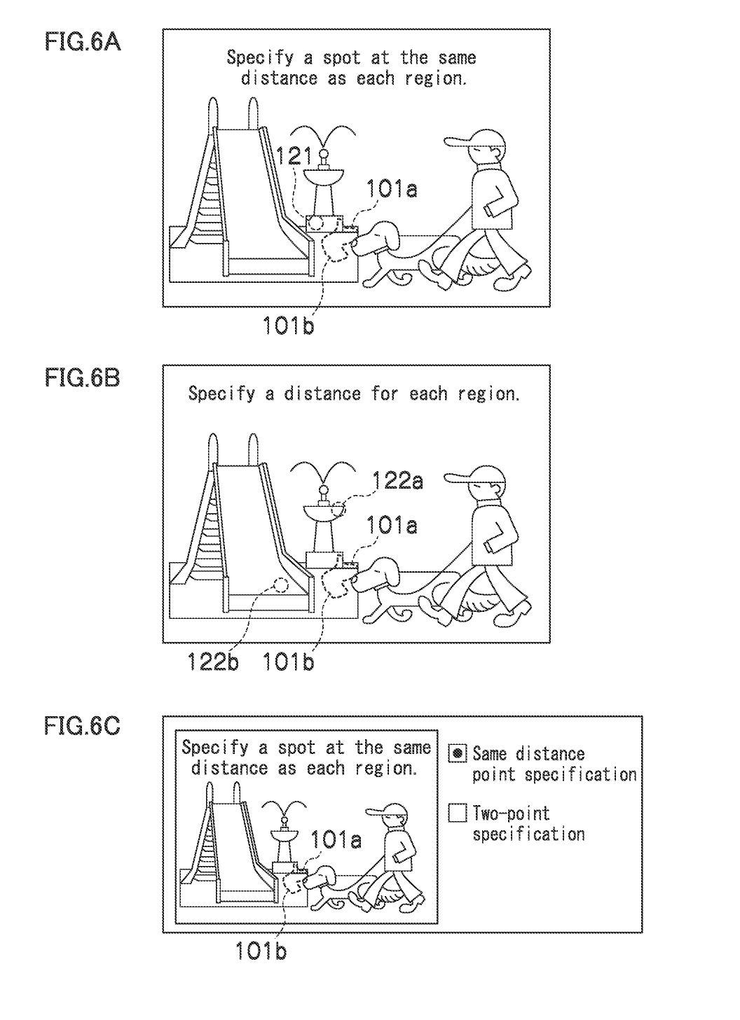

FIG. 6A is a view illustrating an example in which the unknown-parallax regions 101a and 101b are clearly illustrated on the left image used as the reference, and the left image is displayed on the image display section 14. In the example, the unknown-parallax region 101 is displayed surrounded with a dashed frame, and the dividing line 111 is also displayed. The message “Specify a region at the same distance as each region.” is simultaneously displayed in order to prompt a user to specify a region at the same distance as each of the unknown-parallax regions 101a and 101b.

The user specifies a region at the same distance as each unknown-parallax region with use of the pointing device or the like. The parallax setting section 21 reads a parallax for each specified region from the parallax map and sets the parallax as a parallax for the corresponding unknown-parallax region.

For example, a parallax for a region 121 at the same distance as the unknown-parallax region 101a is set as a parallax for the unknown-parallax region 101a by moving a cursor to the unknown-parallax region 101a and clicking the unknown-parallax region 101a and then moving the cursor to the region 121 and clicking the region 121 with use of the pointing device.

After a parallax for an unknown-parallax region is set, the unknown-parallax region is no longer an unknown-parallax region. Accordingly, the display of the unknown-parallax region 101a as an unknown-parallax region may be stopped. For example, after the parallax for the unknown-parallax region 101a is set, only the unknown-parallax region 101b may be displayed surrounded with a dashed frame.

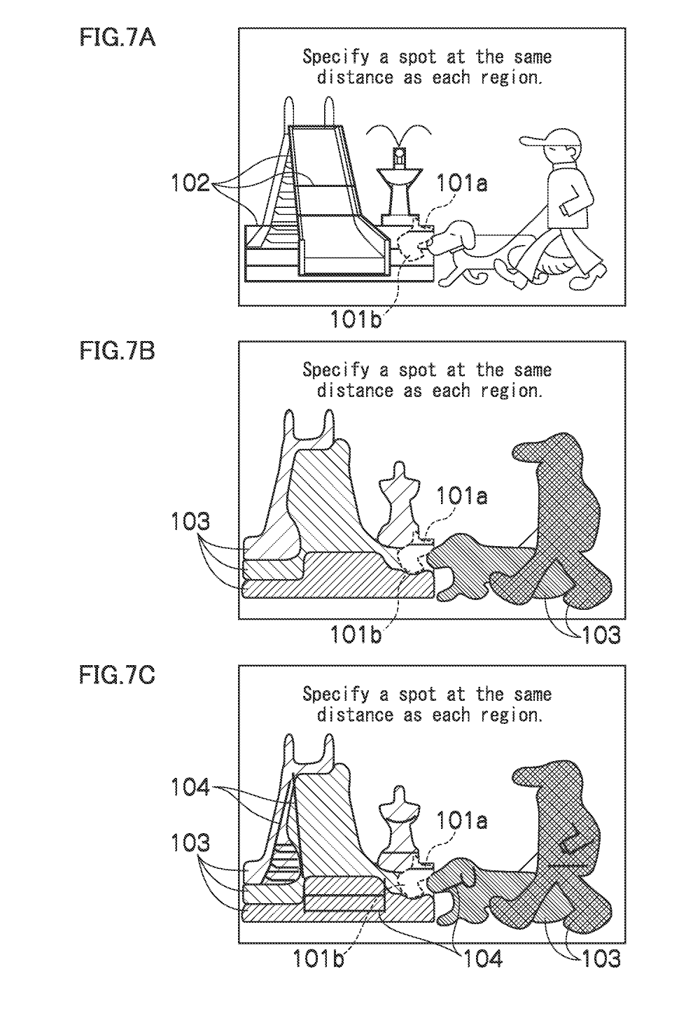

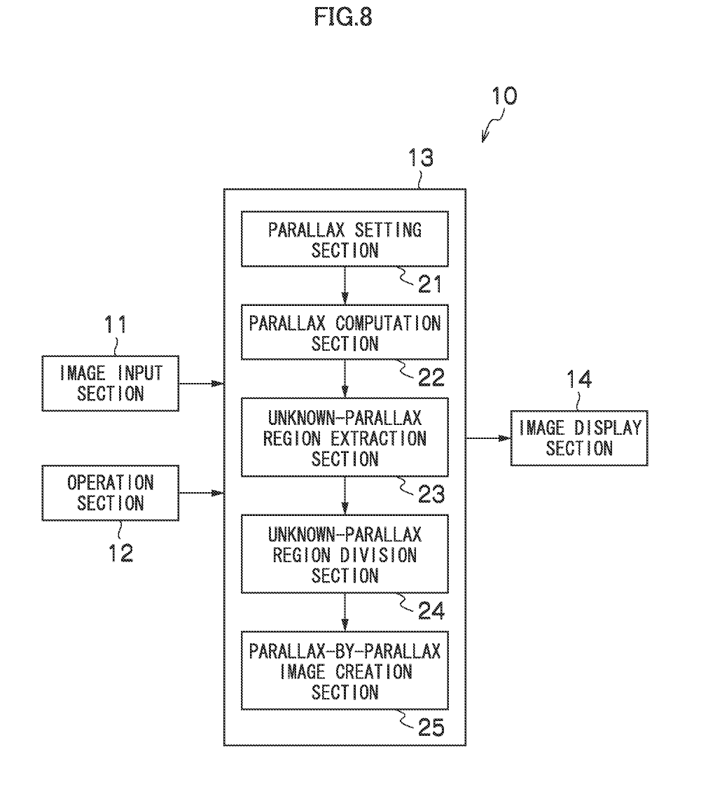

For specification of a region at the same distance as each of the unknown-parallax regions 101a and 101b by the user, pieces of distance information are desirably present in a displayed image. FIG. 7A illustrates an example in which distances are divided into ranges, and the distance border line 102 between adjacent groups of divided distances is superimposed on the image, and the image is displayed on the image display section 14. The user can appropriately specify a region at the same distance as each of the unknown-parallax regions 101a and 101b by checking each distance border line 102.

The parallax image (parallax map) or the distance image may be displayed on the image display section 14. FIG. 7B illustrates an example in which the unknown-parallax regions 101a and 101b are superimposed on the distance image, and the distance image is displayed on the image display section 14. The user can appropriately specify a region at the same distance as each of the unknown-parallax regions 101a and 101b by checking the distance image.

In this case, after the parallax is set for each unknown-parallax region, the unknown-parallax region is preferably displayed in a color with a strength corresponding to the set parallax. The user can check with use of the distance image whether each set parallax is correct. Alternatively, the parallax for each unknown-parallax region may be predicted on the basis of the color information and the like of the reference image, and the unknown-parallax region may be displayed in a color with a strength corresponding to the predicted parallax as an initial value. This method is advantageous in that if the user can confirm that the parallaxes as the initial values are correct, parallax setting operation is unnecessary.

The distance image illustrated in FIG. 7B is devoid of the pictorial information (color information) of the reference image and may be obscure to the user. The color contour lines 104 of the reference image may be displayed superimposed on the distance image, as illustrated in FIG. 7C, to improve visibility for the user.

Other methods for setting a parallax for an unknown-parallax region include the process of specifying two regions in an image and assigning a parallax at a distance intermediate between distances at which the two specified regions are.

FIG. 6B is a view illustrating an example in which the same image as in FIG. 6A is displayed, and the message “Specify a distance for each region.” is simultaneously displayed in order to prompt the user to specify distances for the unknown-parallax regions 101a and 101b.

The user specifies two spots which are away from each unknown-parallax region by the same distance in front of and behind the unknown-parallax region with use of the pointing device or the like. The parallax setting section 21 reads parallaxes for the two specified spots from the parallax map and sets a parallax which is the mean value of the parallaxes as a parallax for the unknown-parallax region.

For example, a parallax intermediate between a parallax for a region 122a in front of the unknown-parallax region 101b by a predetermined distance and a parallax for a region 122b behind the unknown-parallax region 101b by the predetermined distance is set as the parallax for the unknown-parallax region 101a by moving the cursor to the unknown-parallax region 101b and clicking the unknown-parallax region 101b, moving the cursor to the region 122a and clicking the region 122a, and then moving the cursor to the region 122b and clicking the region 122b with use of the pointing device.

This distance specification method is particularly effective when a subject at the same distance is not present in an image.

Note that, as illustrated in FIG. 6C, the configuration may be such that the user can select one of the distance specification method illustrated in FIG. 6A (same distance point specification) and the distance specification method illustrated in FIG. 6B (two-point specification). This configuration allows the user to appropriately specify a distance for each unknown-parallax region.

As described above, a parallax map is created from inputted stereo images, a region for which a parallax cannot be computed is clearly illustrated on a reference image, and a user is prompted to perform division according to parallax and set distances. With this configuration, it is possible to appropriately set a parallax for a region for which parallax computation is impossible, such as an occlusion region.

### Second Embodiment

FIG. 8 is a block diagram illustrating an image processing apparatus 10 according to a second embodiment. Note that the same components as those in the block diagram according to the first embodiment illustrated in FIG. 1 are designated by the same reference numerals, and a detailed description thereof will be omitted. The second embodiment is different from the first embodiment in that a parallax-by-parallax image creation section 25 is provided.

The parallax-by-parallax image creation section 25 divides a reference image into a plurality of parallax-by-parallax images within different predetermined parallax ranges on the basis of a parallax map created by a parallax computation section 22.

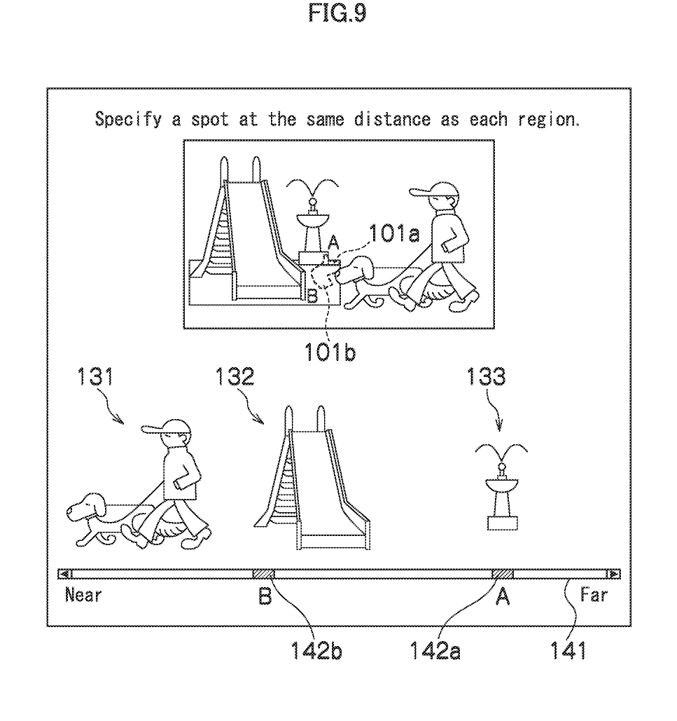

FIG. 9 is a view illustrating a display on an image display section 14 for prompting a user to specify a region at the same distance as each of unknown-parallax regions 101a and 101b. As illustrated in FIG. 9, the unknown-parallax regions 101a and 101b are clearly illustrated on a left image set as a reference, and the message “Specify a spot at the same distance as each region.” for prompting the user to set distances for the unknown-parallax regions 101a and 101b is simultaneously displayed.

Parallax-by-parallax images 131 to 133 created by the parallax-by-parallax image creation section 25 are further arranged in the image display section 14 according to distances of the parallax-by-parallax images 131 to 133 (one at a shorter distance is arranged closer to the left end), and a scroll area 141 including scroll bars 142a and 142b is displayed below the parallax-by-parallax images 131 to 133.

The scroll bars 142a and 142b represent distances for the unknown-parallax regions 101a and 101b. The positions of the scroll bars 142a and 142b are compatible with the distances at which the parallax-by-parallax images 131 to 133 arranged above the scroll bars 142a and 142b are. The scroll bars 142a and 142b are configured to be movable by manipulation of a pointing device or the like.

For example, the user considers that the unknown-parallax region 101a is at the same distance as the parallax-by-parallax image 133 and moves the scroll bar 142a to below the parallax-by-parallax image 133 by manipulating the pointing device. Similarly, the user considers that the unknown-parallax region 101b is at the same distance as the parallax-by-parallax image 132 and moves the scroll bar 142b to below the parallax-by-parallax image 132.

After the positions of the scroll bars 142a and 142b are confirmed, a parallax setting section 21 sets parallaxes corresponding to the positions of the scroll bars 142a and 142b as parallaxes for the unknown-parallax regions 101a and 101b.

Note that the scroll bars 142a and 142b each may be initially arranged at any position. However, it is preferable that distances for the unknown-parallax regions are predicted on the basis of color information and the like of the image and that the scroll bars 142a and 142b are arranged at positions corresponding to the predicted distances.

With the above-described configuration, a user can easily specify a spot at the same distance as each unknown-parallax region.

### Third Embodiment

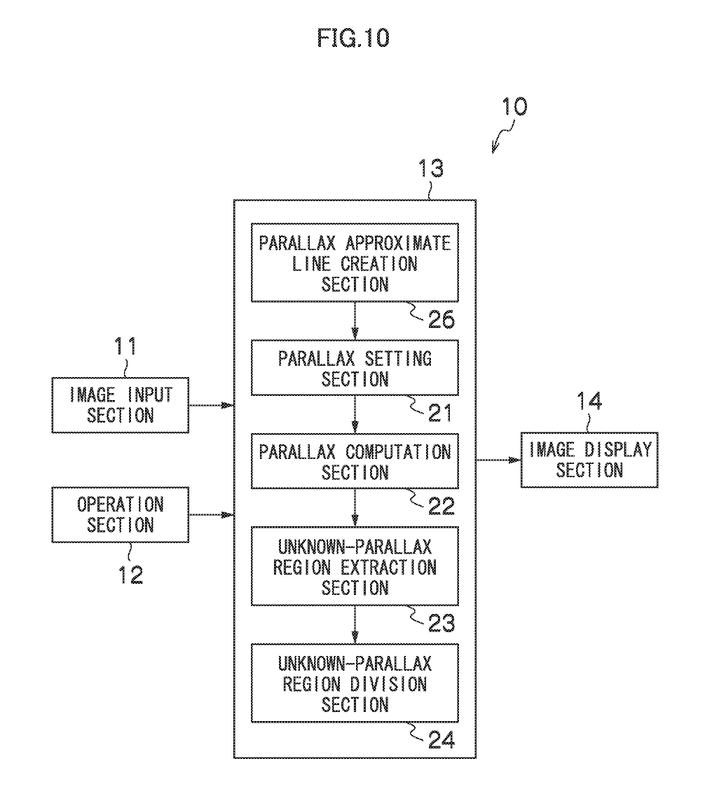

FIG. 10 is a block diagram illustrating an image processing apparatus 10 according to a third embodiment. Note that the same components as those in the block diagram according to the first embodiment illustrated in FIG. 1 are designated by the same reference numerals, and a detailed description thereof will be omitted. The third embodiment is different from the first embodiment in that a parallax approximate line creation section 26 is provided.

The parallax approximate line creation section 26 creates a parallax approximate line on the basis of a reference line entered by a user through an operation section 12. A parallax approximate line refers to a line approximating successive positions on the image and parallaxes at the positions. A parallax setting section 21 sets a parallax for each unknown-parallax region on the basis of the parallax approximate line created by the parallax approximate line creation section 26.

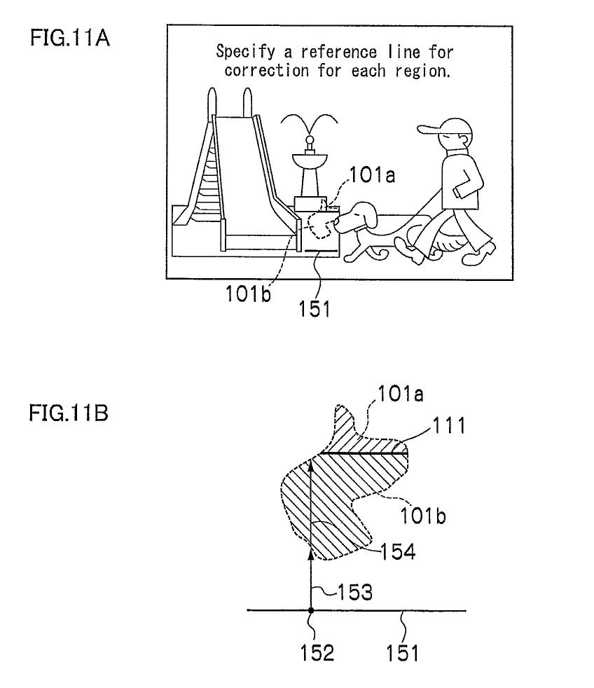

FIG. 11A is a view illustrating an example in which unknown-parallax regions 101a and 101b illustrated on a left image used as the reference with use of a dashed frame and a dividing line is displayed on an image display section 14. The message “Specify a reference line for correction for each region.” is simultaneously displayed in order to prompt the user to enter a reference line for estimating a parallax for each of the unknown-parallax regions 101a and 101b.

The user can enter a reference line for setting a parallax for the unknown-parallax region 101b by, for example, moving a cursor to the unknown-parallax region 101b and clicking the unknown-parallax region 101b and then entering a reference line by dragging with use of a pointing device. In the example in FIG. 11A, a reference line 151 for setting the parallax for the unknown-parallax region 101b is drawn below the unknown-parallax region 101b.

FIG. 11B is a view for explaining processing of the parallax approximate line creation section 26.

The parallax approximate line creation section 26 acquires pieces of parallax information at pixels in a direction perpendicular to the reference line 151 (indicated by an arrow 153) from a pixel at an arbitrary point 152 on the entered reference line 151 to a pixel immediately in front of the unknown-parallax region on the basis of a parallax map and creates a parallax approximate line from the pieces of parallax information. The parallax approximate line creation section 26 extends the parallax approximate line into the unknown-parallax region 101b (as indicated by an arrow 154) and sets a parallax obtained by the extension as a parallax for the unknown-parallax region 101b. The parallax approximate line creation section 26 sweepingly performs the processing while shifting the point 152 along the reference line 151 and sets parallaxes for all pixels within the unknown-parallax region 101b.

Note that although the reference line 151 is drawn in the horizontal direction in the example in FIGS. 11A and 11B, the reference line 151 may be drawn in an arbitrary direction.

As described above, a user can set a parallax for each unknown-parallax region only by entering a reference line. In addition, a high-accuracy parallax can be set for each pixel with use of an approximate line.

What is claimed is:

1. An image processing apparatus comprising:
an image input device configured to input a plurality of images with a parallax between the images;
a parallax computation device configured to set one of the plurality of inputted images as a reference image and compute a parallax for each of pixels of the reference image on the basis of the plurality of images;
a first extraction device configured to extract an unknown-parallax region for which a parallax cannot be computed by the parallax computation device;
a display control device configured to display the unknown-parallax region on a display device;
an input device configured to receive a user input of information on a parallax for the unknown-parallax region from a user; and
a parallax setting device configured to set the parallax for the unknown-parallax region on the basis of the input information on the parallax.

2. The image processing apparatus according to claim 1, wherein the input device includes:
a specification device configured to receive a user instruction to specify any one region within the plurality of images; and
an acquisition device configured to acquire a parallax computed by the parallax computation device for the specified region, and
the parallax setting device sets the parallax acquired by the acquisition device as the parallax for the unknown-parallax region.

3. The image processing apparatus according to claim 1, wherein
the input device includes:
a specification device configured to receive an user instruction to specify any two regions within the plurality of images;
an acquisition device configured to acquire parallaxes computed by the parallax computation device for the two specified region; and
an intermediate parallax computation device configured to compute a parallax intermediate between the two parallaxes acquired by the acquisition device, and
the parallax setting device sets the parallax computed by the intermediate parallax computation device as the parallax for the extracted unknown-parallax region.

4. The image processing apparatus according to claim 1, further comprising:
an acquisition device configured to receive a user instruction to specify any one region within the plurality of images and acquire a parallax computed by the parallax computation device for the specified region;
an intermediate parallax computation device configured to receive a user instruction to specify any two regions within the plurality of images, acquire parallaxes computed by the parallax computation device for the two specified regions, and compute a parallax intermediate between the two acquired parallaxes; and
a selection device configured to select from a first option of setting the parallax acquired by the acquisition device as the parallax for the unknown-parallax region by the parallax setting device and a second option of setting the parallax computed by the intermediate parallax computation device as the parallax for the unknown-parallax region by the parallax setting device.

5. The image processing apparatus according to claim 1, further comprising
a first dividing device configured to divide the unknown-parallax region into a plurality of regions, wherein
the input device receives a user input of information on the parallax for the unknown-parallax region for each of the divided regions.

6. The image processing apparatus according to claim 1, wherein
the display control device superimposes the unknown-parallax region on at least one of the plurality of images and displays the at least one image on the display device.

7. The image processing apparatus according to claim 1, further comprising
a second dividing device configured to divide the reference image into components within different predetermined distance ranges on the basis of the parallaxes for the pixels computed by the parallax computation device, wherein
the display control device superimposes a dividing line by which the reference image is divided on the reference image and displays the reference image.

8. The image processing apparatus according to claim 1, further comprising
a generating device configured to generate a parallax image of the reference image on the basis of the parallaxes for the pixels computed by the parallax computation device, wherein
the display control device superimposes the unknown-parallax region on the parallax image and displays the parallax image on the display device.

9. The image processing apparatus according to claim 8, further comprising
a second extraction device configured to extract a color contour from the reference image, wherein
the display control device superimposes the color contour on the parallax image and displays the parallax image on the display device.

10. The image processing apparatus according to claim 1, further comprising
a parallax-by-parallax image generating device configured to divide the reference image according to parallax on the basis of the parallaxes for the pixels computed by the parallax computation device and generate a plurality of parallax-by-parallax images, wherein
the display control device displays the parallax-by-parallax images in order of parallax on the display device, and
the input device receives a user input of information on the parallax for the unknown-parallax region in association with positions of the parallax-by-parallax images displayed in order of parallax.

11. The image processing apparatus according to claim 1, wherein
the input device receives an user input of a reference line with respect to the unknown-parallax region displayed on the display device which is information on the parallax for the unknown-parallax region, and
the parallax setting device includes:
a parallax approximate line generating device configured to generate a parallax approximate line on the basis of the reference line and
a parallax setting device configured to set the parallax for the unknown-parallax region on the basis of the parallax approximate line.

12. An image processing method comprising:
an image input step of inputting a plurality of images with a parallax between the images;
a parallax computation step of using one of the plurality of inputted images as a reference image and computing a parallax for each of pixels of the reference image on the basis of the plurality of images;
an extraction step of extracting an unknown-parallax region for which a parallax cannot be computed by the parallax computation step;
a display control step of displaying the unknown-parallax region on a display device;
an input step of receiving a user input of information on a parallax for the unknown-parallax region from a user; and
a parallax setting step of setting the parallax for the unknown-parallax region on the basis of the input information on the parallax.
